(19) United States
(12) Patent Application Publication
(10) Pub. No.: US 2011/0155536 A1
(43) Pub. Date: Jun. 30, 2011

(54) MEDIUM PROCESSING DEVICE

(75) Inventors: Hajime Togiya, Gunma (JP); Atsushi Takada, Gunma (JP)

(73) Assignee: Oki Electric Industry Co., Ltd., TOKYO (JP)

(21) Appl. No.: 13/062,537

(22) PCT Filed: Jun. 2, 2010
(86) PCT No.: PCT/JP2010/059303

§ 371 Date: Mar. 7, 2011

(30) Foreign Application Priority Data
Jun. 16, 2009 (JP) 2009-143755 2009

(51) Int. Cl. G07F 7/04

(52) U.S. Cl. 194/206

(57) ABSTRACT

The conveying path of an automated teller machine is shortened such that banknote jams are suppressed from occurring. The automated teller machine includes a customer interface section 1 with a deposit/withdrawal port for banknotes, an examination section 3 that examines banknotes, a temporary holding section 4 that holds banknotes, a switching blade 6 that switches the conveying direction of banknotes that have been examined by the examination section 3, a switching timing sensor 5 that detects a switching timing of the switching blade 6, and denominated cassettes 11 that stores banknotes, and these components are connected with the conveying path. A circular arc shaped conveying path 20 formed in a circular arc shape is provided in the conveying path, at a portion connecting from the examination section 3 to the customer interface section 1.

### TECHNICAL FIELD

The present invention relates to a medium processing device, such as installed to an Automated Teller Machine (ATM) or the like.

### BACKGROUND ART

As a conventional medium processing device, when a customer places banknotes in a customer interface section during a deposit transaction with an automated teller machine, the inserted banknotes are conveyed by a conveying path from the customer interface section to an examination section for examining the denomination and authenticity of the banknotes. Banknotes diagnosed by the examination section to be authentic banknotes are conveyed to a temporary holding section where they are temporary held. However, banknotes diagnosed to be rejected banknotes by the examination section are returned to the customer interface section by the conveying path and returned to the customer. When the customer confirms the deposit amount, the banknotes held in the temporary holding section are subjected to re-examination of their denomination by the examination section, and then stored in a respective denominated cassette by a conveying path according to their diagnosed denominations.

In a withdrawal transaction, when the customer has entered the amount to be withdrawn, banknotes are fed out from each denominated cassette along the conveying path to the examination section. Banknotes diagnosed as being authentic banknotes by the examination section are conveyed along a conveying path to the customer interface section and paid out to the customer. However, any banknotes diagnosed as being rejected banknotes by the examination section are conveyed from the examination section along a conveying path to a reject store where they are collected (see, for example, Japanese Patent Application Laid-Open (JP-A) No. 2008-217465).

### DISCLOSURE OF THE INVENTION

### Problem to be Solved by the Invention

In such conventional technology, each of the functional sections for performing banknote telling, such as the customer interface section, the examination section, the temporary holding section, the denominated cassettes, the reject store and the like, are connected by conveying paths. Therefore, the conveying paths must be disposed in narrow locations within the machine in order to make the machine itself as compact as possible. Accordingly, requirements arise for conveying paths, configured with turning sections inflected at angles of 90° or less, wave shaped conveying paths with entrained belts for generating feeding force for belt conveying, and conveying paths with detour routes to achieve the length in order to secure distance from the examination section to switching timing sensors as long as computation time for performing examination in the examination section can be ensured, and the like. Due to these, an issue arises in that banknote jams occur more readily, and the configuration of the conveying paths becomes more complicated, leading to an increase in manufacturing cost.

Furthermore, a rejected banknote (withdrawal-rejected banknote) in the withdrawal process is conveyed to the reject store set for rejects after passing through the examination section. Accordingly a switching blade for switching the conveying direction of a withdrawal-rejected banknote towards the reject store, and a switching timing sensor for detecting switching timing of the switching blade, are required at a position immediately downstream the examination section. The conveying path of banknotes in the deposition process, from the examination section to the temporary holding section disposed downstream of the examination section, is thereby increased in length, with this leading to the problem that banknote jams more readily occur when conveying deposited banknotes.

The present invention is made to address such issues.

### Means for Solving the Problem

The present invention is a medium processing device including: a customer interface section with an deposit/withdrawal port for a banknote; an examination section that examines a banknote; a temporary holding section that holds a banknote; a switching blade that switches conveying direction of the banknote that has been examined by the examination section; a switching timing sensor that detects a switching timing of the switching blade; a denominated cassette that stores a banknote; and a conveying path that connects each of the sections, the conveying path comprises a circular arc shaped conveying path formed in a circular arc shape at a portion of on the conveying path where connecting from the examination section to the customer interface section.

### Effect of the Invention

The present invention configured as above can thus connect together the customer interface section, the banknote examination section, the temporary holding section and the denominated cassette with a short distance, and can also make the turning section of the conveying path gentle, whereby an effect is obtained of being able to realize stable conveying with fewer banknote jams occurring.

### BRIEF DESCRIPTION OF THE DRAWINGS

FIG. 1 is an explanatory diagram showing a configuration of an automated teller machine of a first exemplary embodiment.

FIG. 2 is an explanatory diagram showing a circular arc conveying path of the first exemplary embodiment.

FIG. 3 is an explanatory diagram showing a configuration of an automated teller machine of a second exemplary embodiment.

FIG. 4 is a perspective view of the external appearance of a drive roller of the second exemplary embodiment.

FIG. 5 is an explanatory diagram of mounting of a switching timing sensor of the second exemplary embodiment.

FIG. 6 is an explanatory diagram of mounting of the switching timing sensor of the second exemplary embodiment.

FIG. 7 is an explanatory diagram of mounting of the switching timing sensor of the second exemplary embodiment.

FIG. 8 is an explanatory diagram showing relevant portions of a configuration of an automated teller machine of a third exemplary embodiment.

FIG. 9 is an explanatory diagram showing a branching section of the third exemplary embodiment.

FIG. 10 is a perspective view showing a drive roller of a fourth exemplary embodiment.

FIG. 11 is front view showing the drive roller of the fourth exemplary embodiment.

FIG. 12 is an explanatory diagram showing a placement state of a switching timing sensor in the fourth exemplary embodiment.

FIG. 13 is an explanatory diagram showing a placement state of a remnant detection sensor of a fifth exemplary embodiment.

### BEST MODE FOR IMPLEMENTING THE INVENTION

Explanation follows of exemplary embodiments of the present invention, with reference to the drawings.

### First Exemplary Embodiment

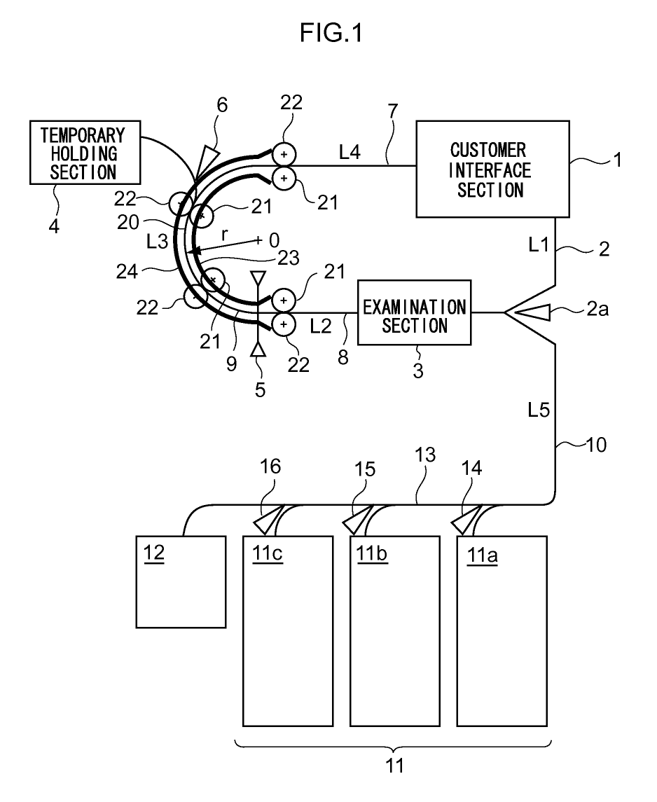

FIG. 1 is an explanatory diagram showing a configuration of an automated teller machine of a first exemplary embodiment.

In FIG. 1, a customer interface section 1 has a money deposit/withdrawal port for placing deposit banknotes in and for taking out withdrawn banknotes. A conveying path 2, for conveying banknotes separated and conveyed out from the customer interface section 1, is provided partway along with a switching blade 2a. An examination section 3 performs various examinations on the banknotes, such as regarding the denomination, authenticity, running state and the like of the banknotes. A temporary holding section 4 collects and temporarily holds authentic banknotes taken in during depositing and withdrawal-rejected banknotes.

An optical switching timing sensor 5 detects switching timing of a switching blade 6 for switching the conveying direction of banknotes, either towards the customer interface section 1 or the temporary holding section 4. A conveying path 7 is a conveying path for returning to the customer interface section 1 reject banknotes (withdrawal-rejected banknotes) that have been diagnosed by the examination section 3 during depositing as having abnormal conveying, as being fake notes or the like. A conveying path 8 extends from the examination section 3 to the switching timing sensor 5. A conveying path 9 extends from the switching timing sensor 5 to the switching blade 6. A conveying path 10 connects from the switching blade 2a provided on the conveying path 2 to denominated cassettes 11 capable of both storing and dispensing.

The denominated cassettes 11 includes plural cassettes 11a, 11b, 11c, and store banknotes separately by denomination according to set denominations. Note that there is no limitation to three denominated cassettes, and any desired number thereof may be provided.

A reject store 12 stores withdrawal-rejected banknotes and any banknotes that have been forgotten and left behind. A sorting conveying path 13 extends from the denominated cassettes 11 to the reject store 12. A blade 14 sorts banknotes into the denominated cassette 11a. A blade 15 sorts banknotes into the denominated cassette 11b. A blade 16 sorts banknotes into the denominated cassette 11c.

In the above configuration, the length of the conveying path 2 from the customer interface section 1 to the examination section 3 is denoted length L1. The length of the conveying path 8 from the examination section 3 to the switching timing sensor 5 is denoted length L2. The length of the conveying path 9 from the switching timing sensor 5 to the switching blade 6 is denoted length L3. The length of the conveying path 7 from the switching blade 6 to the customer interface section 1 is denoted length L4. The length of the conveying path 10 from the switching blade 2a on the conveying path 2 to the blade 14 is denoted length L5.

Explanation now follows regarding operation of the above configuration.

When the banknotes placed in the customer interface section 1 have been separated into single notes, determination that they are separable is made by a monitoring sensor, not shown in the drawings, and a banknote is fed out to the conveying path 2. The fed out banknote is conveyed to the examination section 3 by the conveying path 2, and after examination in the examination section 3 the banknote passes along the conveying path 8 and the conveying path 9.

Then a normal banknote is switched by the switching blade 6 towards the temporary holding section 4, where it is taken in and collected. A deposit-rejected banknote is conveyed through the conveying path 7 to the customer interface section 1.

The length L1 of the conveying path 2 is set to be a length required for determining whether a banknote fed out from the customer interface section 1 is able to be conveyed by the monitoring sensor.

The length L2 of the conveying path 8 is set to be a length required for completion of examination of authenticity and a running state of the banknote by the examination section 3 while the banknote passes through the examination section 3.

The length L3 of the conveying path 9 from the switching timing sensor 5 to the switching blade 6 is set in consideration of the length the banknote is conveyed, during the time from the switching timing sensor 5 detecting the banknote till switching by the switching blade 6, and the leading portion of the leading edge of the banknote which has been skewed (run obliquely).

Any deposit-rejected banknote is conveyed by the switching blade 6 towards the conveying path 7. The shorter the length L4 set for the conveying path 7 the better.

Hence, a conveying path shape set with the shortest L1+L2+L3+L4 is the ideal conveying path when depositing.

After confirmation of deposit, in order to store a banknote in one of the denominated cassettes 11, the banknote fed out from the temporary holding section 4 is switched by the switching blade 6 to the conveying path 9, and conveyed by the conveying path 8 to the examination section 3 for re-examination. Then, the banknote is switched by the switching blade 2a, and conveyed by the conveying path 10 to the appropriate denominated cassette 11a, 11b, 11c according to the diagnosed denomination, where the banknote is stored.

Hence, a conveying path shape set with the shortest L2+L3+L5 is the ideal conveying path when storing.

A banknote for withdrawal is fed out from the respective denominated cassette 11a, 11b, 11c and conveyed by the conveying path 10. Then the banknote is switched by the switching blade 2a, conveyed by the conveying path 2 to the examination section 3, and the banknote is examined in the examination section 3. After examination of the banknote, a withdrawal-rejected banknote passes along the conveying path 8 and the conveying path 9, is switched by the switching blade 6 and collected in the temporary holding section 4. The banknote for withdrawal is conveyed by the conveying path 7 to the customer interface section 1.

Note that, any withdrawal-rejected banknotes collected in the temporary holding section 4 during withdrawal are fed out from the temporary holding section 4, for example when the withdrawal transaction has been completed. Then, similarly to the storage operation when depositing, the withdrawal-rejected banknotes are conveyed to the reject store 12 and stored.

Hence, a conveying path shape set with the shortest L5+L2+L3+L4 is the ideal conveying path when withdrawal.

The present exemplary embodiment utilizes a circular arc shaped conveying path 20 in order to realize the above ideal conveying path shape when depositing, when storing, and when withdrawing.

Normally the vertical and horizontal dimensions of the machine are specified, and there is also a requirement for banknotes placed in the customer interface section 1 to be returned again to the customer interface section 1. Accordingly, this leads to the conveying path between the examination section 3 and the customer interface section 1 being connected together in a loop shape by the conveying paths 8, 9, and 7.

When a loop shaped conveying path connected from the examination section 3 to the customer interface section 1 is formed with straight lines connecting been the tangential direction of plural rollers configuring the loop shaped conveying path, there may be tight inflection at turning portions of the loop.

Accordingly, the circular arc shaped conveying path 20 is provided with a relatively large circular arc (a semi-circular arc in the present exemplary embodiment) connecting between the rollers at a portion of the conveying path 8 (length L2), the conveying path 9 (length L3) and the conveying path 7 (length L4) connecting between the examination section 3 and the customer interface section 1. Hence, the length of L2+L3+L4 is shortened, and sudden inflection in the turning portion is removed.

The circular arc shaped conveying path 20 of the present exemplary embodiment is, as shown in FIG. 1, configured with plural feed rollers 21, pressure rollers 22 disposed facing the feed rollers 21, and a pair of conveying guides 23, 24 that act as banknote guides for banknotes being nipped and conveyed by the feed rollers 21 and the pressure rollers 22. The circular arc shaped conveying path 20 formed with a circular arc, tangentially contacted on the inside by the plural feed rollers 21, is configured to be a conveying path having a turning portion of gentle radius of curvature.

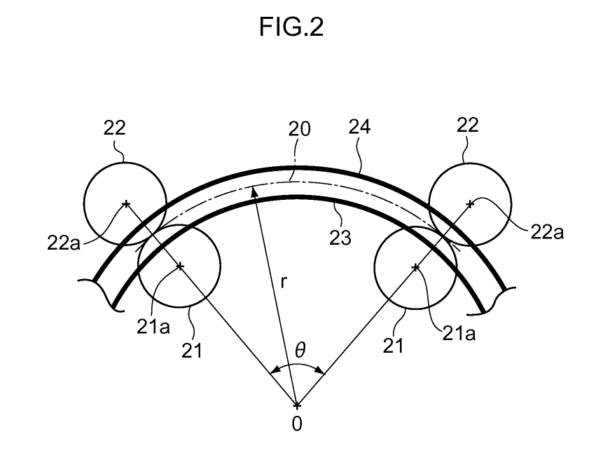

Detailed explanation follows regarding the circular arc shaped conveying path 20, with reference to FIG. 2.

The feed rollers 21 are rotationally driven in a forward and reverse direction by a drive source, not shown in the drawings, about rotational axes 21a lying in a direction orthogonal to the banknote conveying direction.

The pressure rollers 22 are disposed facing the feed rollers 21, at the outer side of the pressure rollers 22 in the radial direction with respect to the center of curvature O (the intersection point of two normal lines to the circular arc) of the circular arc of the circular arc shaped conveying path 20. The pressure rollers 22 are provided with their rotational axes 22a disposed parallel to the rotational axes 21a of the feed rollers 21. The pressure rollers 22 are pressed against the outer surface of the feed rollers 21 by respective spring members, not shown in the drawings, such that the pressure rollers 22 rotate following the rotation of the feed rollers 21.

The pair of conveying guides 23, 24 are each formed in a circular arc shape centered on the center of curvature O of the circular arc shaped conveying path 20, disposed facing each other on either side of the circular arc shaped conveying path 20. The pair of conveying guides 23, 24 are configured so as to guide the front and back faces of the banknotes being nipped and conveyed by the feed rollers 21 and the pressure rollers 22.

The distance between two adjacent nip portions of the feed rollers 21 and the pressure rollers 22 is set to be inter-roller conveying length L, which is shorter than the conveying direction length of the banknotes to be conveyed. When the internal angle formed by these nip portions with respect to the center of curvature O is denoted internal angle θ, and the radius of the circular arc of the circular arc shaped conveying path 20 is denoted radius r,

r=(L/2π)×360/θ Equation (1).

Accordingly, the circular arc shaped conveying path 20 in the example shown of the present exemplary embodiment is formed with a circular arc of radius r centered around the center of curvature O. The circular arc shaped conveying path 20 forms a conveying path with the plural feed rollers 21 disposed at a roller pitch forming internal angle θ and has the inter-roller conveying length L.

The circular arc shaped conveying path 20 configured as above can shorten the conveying path 8, the conveying path 9 and the conveying path 7 connecting from the customer interface section 1 to the examination section 3, and can make bending in the turning portion of the conveying route gentle. Accordingly, occurrence of banknote jams can be suppressed.

Further, an automated teller machine can be configured with a reduced number of configuration components of the conveying path 8 connecting from the examination section 3 to the customer interface section 1, and can realize stable banknote conveying at lower cost.

Furthermore, withdrawal-rejected banknotes are temporarily collected in the temporary holding section 4 branching off at the switching blade 6 from the circular arc shaped conveying path 20. Accordingly, provision of a separate conveying path for conveying to the reject store 12 is no longer required, the conveying route connecting from the examination section 3 to the temporary holding section 4 can be shortened, and banknote jams can be suppressed from occurring. Thus, an automated teller machine is achieved in which the number of configuration components can be reduced, and stable banknote conveying can be realized at lower cost.

According to the configuration above, a circular arc shaped conveying path formed in a circular arc shape is provided to the conveying path connecting from the examination section to the customer interface section. Consequently, the distance of the banknote conveying route is shortened, inflected paths can be avoided, and banknote jams can be suppressed from occurring.

### Second Exemplary Embodiment

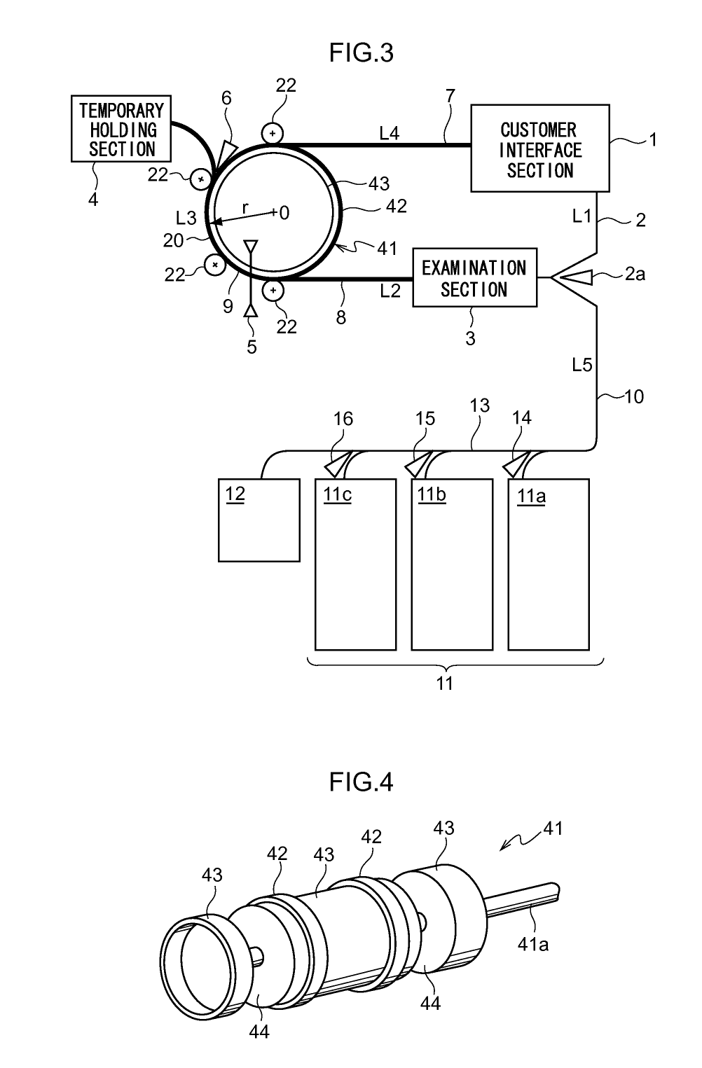

FIG. 3 is an outline explanatory diagram showing an automated teller machine of the present exemplary embodiment. Note that similar portions to those of the first exemplary embodiment are allocated the same reference numerals and further explanation thereof is omitted.

In FIG. 3, a circular cylindrical shaped drive roller 41, provided with its rotational axis 41a lying at the center of curvature O of the circular arc shaped conveying path 20 along a direction orthogonal to the banknote conveying direction, is rotationally driven in a forward and reverse direction about the drive roller 41a by a drive source, not shown in the drawings.

As shown in FIG. 4, the drive roller 41 is a circular cylindrical shaped roller provided with friction members 42, formed from rubber or the like, at portions that contact each of the pressure rollers 22 shown in FIG. 3. The outer surfaces of the friction members 42 are formed with a radius r centered about center of curvature O, with this radius r being the same as the radius r of the circular arc of the circular arc shaped conveying path 20 described in the first exemplary embodiment.

Portions of the drive roller 41 other than at the friction members 42 are configured with a circular cylindrical shape of smaller radius, with the outer surface at these portions formed similarly to the circular arc faces of the conveying guide 23 of the first exemplary embodiment. Guide faces 43 are configured by this outer surface, so as to guide banknotes being nipped and conveyed between the friction members 42 and the pressure rollers 22.

The rotational axis 22a of each of the pressure rollers 22 is disposed parallel to the rotational axis 41a of the drive roller 41, and, similarly to in the first exemplary embodiment, each of the pressure rollers 22 are disposed at a roller pitch so as to form an internal angle θ.

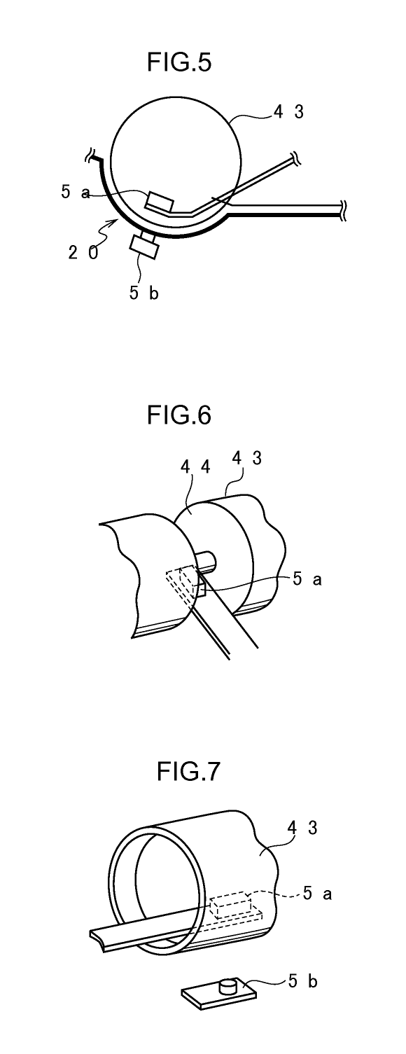

As shown in FIG. 5 and FIG. 6, a switching timing sensor 5 in this embodiment is provided with a sensor element 5a disposed inside a small diameter section 44 formed in the guide face 43 of the drive roller 41, and a sensor element 5b disposed at the outer side in the radial direction of the circular arc shaped conveying path 20 and facing the sensor element 5a.

Note that, as shown in FIG. 7, configuration may be made with the guide face 43 of the drive roller 41 configured with a transparent material, and the switching timing sensor 5 may be configured such that the sensor element 5a is placed inside the cylinder of the guide face 43 and inserted along the axial direction thereof, and the sensor element 5b may be disposed at the outer side in the radial direction of the circular arc shaped conveying path 20 so as to facing the sensor element 5a.

The circular arc shaped conveying path 20 configured thus can shorten the conveying path 8, the conveying path 9 and the conveying path 7 connecting from the examination section 3 to the customer interface section 1, and can make bending of the conveying route in the turning portion more gentle, and accordingly can suppress banknote jams from occurring, similarly to in the first exemplary embodiment.

Further, a banknote conveyed from the examination section 3 is nipped between the friction members 42 and the pressure rollers 22, and conveyed along with rotation of the drive roller 41. Accordingly, since the banknote is conveyed in a stationary state with respect to the drive roller 41, impact and catching against conveying guides due to the condition of the banknote is reduced, and banknote jams can be further suppressed from occurring.

In addition, since there is substantially no relative movement between the banknote and the drive roller 41, there is less generation of static electricity due to friction, a reduction in noise to electrical circuits can be achieved, and the banknote can be prevented from sticking to the drive roller 41.

Moreover, the circular arc shaped conveying path 20 of the present exemplary embodiment is configured with the circular cylindrical shaped drive roller 41 provided with the friction members 42 and the guide face 43, and the pressure rollers 22 for pressing against the outer surface of the friction members 42. Consequently, the drive roller 41 can also act as the conveying guide 23 of the first exemplary embodiment, and configuration can be made at even lower cost.

Similar effects to those of the first exemplary embodiment are obtained with the above configuration, and banknotes are also conveyed in a stationary state with respect to the drive roller. Hence further suppression of banknote jams from occurring can be achieved.

Further, since there is little friction between the banknote and the drive roller, there is also little generation of static electricity, noise to circuits can be reduced, and banknotes can be prevented from sticking to the drive roller.

### Third Exemplary Embodiment

The present exemplary embodiment is applicable to the configuration of both the first exemplary embodiment and the second exemplary embodiment, and explanation follows of application to the second exemplary embodiment of the present invention.

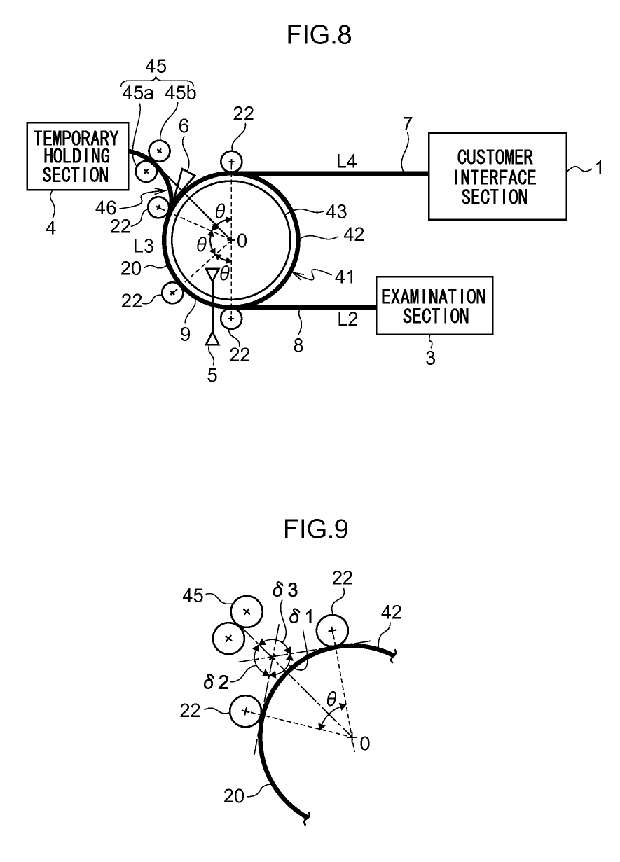

FIG. 8 is an explanatory diagram of a configuration of relevant portions of an automated teller machine of the present exemplary embodiment, with similar portions to those of FIG. 3 of the second exemplary embodiment allocated the same reference numerals, and further explanation thereof omitted.

As shown in FIG. 8, in order to convey from the circular arc shaped conveying path 20 towards the temporary holding section 4, a roller pair 45 is provided at a position directly downstream in conveying direction where the conveying path has been switched by the switching blade 6 provided at a branching section 46. The roller pair 45 includes a feed roller 45a that is driven in a forward and reverse direction by a drive source, not shown in the drawings, and a pressure roller 45b for pressing against the feed roller 45a.

As shown in FIG. 9, intersection angle δ1 indicates the intersection angle at an intersection point of a tangent at the nip portion between the drive roller 41 and the pressure roller 22 provided at one side of the branching section 46 in the circumferential direction of the drive roller 41 (the pressure roller 22 disposed at the leading end side of the switching blade 6 in FIG. 8), and a tangent at the nip portion between the drive roller 41 and the pressure roller 22 provided at the opposite side to the first side pressure roller 22 with respect to the branching section 46 (the pressure roller 22 disposed at the customer interface section 1 side of the first side pressure roller 22 in FIG. 8).

Intersection angle δ2 indicates the intersection angle at an intersection point of a tangent at the nip portion between the drive roller 41 and the first side pressure roller 22, and a tangent at the nip portion of the roller pair 45.

Intersection angle δ3 indicates the intersection angle at an intersection point of a tangent to the nip portion of the roller pair 45 and the tangent to the nip portion between the drive roller 41 and the opposite side pressure roller 22.

The above three intersection points are designed to coincide, and the conveying path after branching off from the circular arc shaped conveying path 20 towards the temporary holding section 4 is formed by a circular arc with a tangent to the connection point with the circular arc shaped conveying path 20 coinciding to that of the circular arc shaped conveying path 20. The distance between the first side pressure roller 22 and the roller pair 45 is set to be the inter-roller conveying length L of the first exemplary embodiment. The rollers are disposed so as to form the intersection angles δ1, δ2, δ3 at 120°.

Accordingly, the conveying direction towards the roller pair 45 makes a right angle to the center O of curvature of the circular arc shaped conveying path 20, and each conveying direction leading out from the first side pressure roller 22 is set to be the tangent of the circular arc shaped conveying path 20.

The angle θ formed here between adjacent pressure rollers 22 is 60°, which gives a state in which the pressure rollers 22 are disposed on the circular arc shaped conveying path 20 every 60°. Note that the internal angle θ between rollers need not be exactly 60°, and configuration may be made in the vicinity of 60°.

Furthermore, the radius r of the circular arc shaped conveying path 20 is derived from Equation (1) based on the inter-roller conveying length L and the internal angle θ (60°), the conveying route of the circular arc shaped conveying path 20 is thereby determined, and this is applied to the present exemplary embodiment.

Note that an arrangement of the roller pair 45 may be similar with that in a case in which the circular arc shaped conveying path 20 is configured by the feed rollers 21 and the pressure rollers 22 as in the first exemplary embodiment.

Similar effects are obtained according to the above configuration as those of the first exemplary embodiment. Furthermore, when there is a branching section in the circular arc shaped conveying path, by making the roller pitch on the circular arc shaped conveying path 60°, the conveying path after the branching section may provide conveyance in a gently curving state similar to that in the circular arc shaped conveying path, without unnecessary roller disposition on the conveying path. Furthermore, the machine can accordingly be more compact, and at the same time, achieve smooth conveying, which reduces occurrences of jams.

### Fourth Exemplary Embodiment

The present exemplary embodiment is the above second exemplary embodiment, with modified drive roller construction.

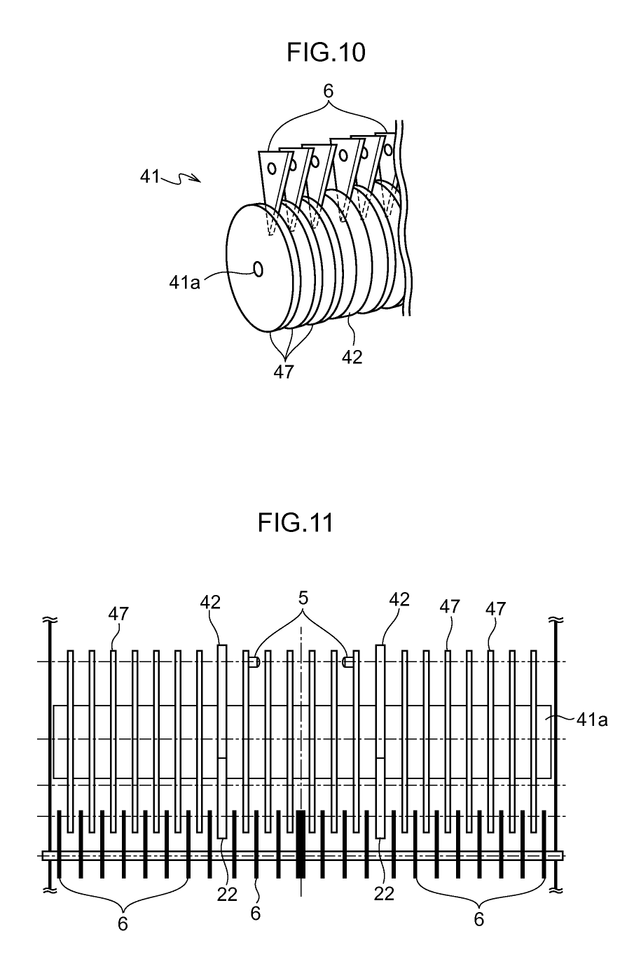

FIG. 10 is a perspective view of the drive roller and FIG. 11 is a front view of the drive roller. Similar portions to those of FIG. 3 in the second exemplary embodiment are allocated the same reference numerals, and further explanation thereof omitted.

As shown in FIG. 10 and FIG. 11, a drive roller 41 of the present exemplary embodiment has a structure in which circular plates 47 are attached in a ribbed shape with intervals along a central rotational axis 41a. The leading ends of switching blades 6 are inserted between these circular plates 47. The diameter of these circular plates 47 is formed so as to be the same as that of the guide face 43 of the second exemplary embodiment, so as to guide the banknotes being conveyed.

The circular plates 47 mounted with friction members 42 similar to those of the first exemplary embodiment are also disposed along the outer periphery of the rotational axis 41a at narrower intervals than the banknote width in the direction orthogonal to the conveying direction. The diameter of the outer surface of the friction members 42 is formed so as to be the same as the outer surface diameter of the friction members 42 of the second exemplary embodiment, with the pressure rollers 22 disposed so as to face the friction members 42 (see FIG. 11).

Note that the circular plates 47 mounted with the friction members 42 may be configured as a whole similarly to the friction members 42. Further, the width of the circular plates 47 mounted with the friction members 42 is shown wider in the drawings than the width of the other circular plates 47, however configuration may be made with the same dimension for both types.

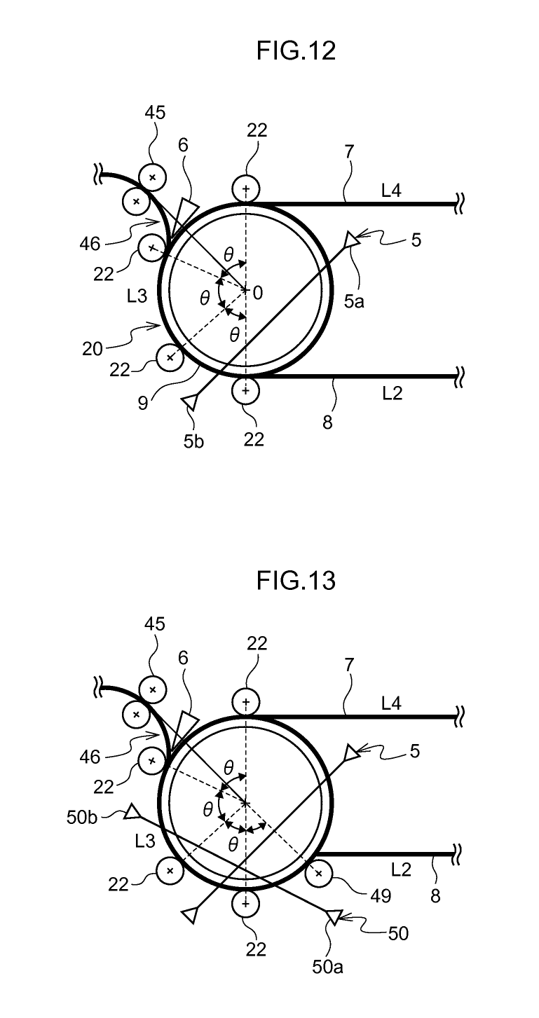

As shown in FIG. 11, the switching timing sensors 5 of the present exemplary embodiment are disposed between the circular plates 47, and, as shown in FIG. 12, sensor elements 5a, 5b are disposed facing each other at the external of the drive roller 41. Configuration is made such that the optical axes of the sensor elements 5a, 5b pass between the circular plates 47.

If the sensor element 5a is disposed inside the drive roller 41, the shape of a mounting bracket would be complicated, or resulting in adoption of a weak shape in strength. However, as in the present exemplary embodiment, by mounting to the outside of the drive roller 41, the mounting of the switching timing sensors 5 is enabled with simple mounting method and with a shape achieving high strength.

According to such a configuration, banknotes being conveyed are nipped between the friction members 42 of the drive roller 41, configured by the circular plates 47 mounted in a ribbed shape, and the pressure rollers 22, can be switched in conveying direction by the switching blades 6 inserted between the circular plates 47, enabling smooth direction switching.

Similar effects are obtained by the above configuration to those of the first exemplary embodiment. Further, the drive roller is configured with plural circular plates, with the switching blades disposed with their tip ends inserted between the circular plates. Accordingly, smooth switching of direction is performed by the switching blades, and the contact surfaces of the drive roller contact with the banknotes are reduced, thereby suppressing generation of static electricity due to friction.

Furthermore, by suppressing generation of static electricity due to friction, noise to circuits is reduced, and banknotes can be prevented from sticking to the drive roller.

Moreover, the switching timing sensors are disposed at the outside of the drive roller with their optical axes passing through between the circular plates. Accordingly, the configuration of the switching sensors can be made simple which enables easy mounting operation, while providing high strength to the mounting structure.

### Fifth Exemplary Embodiment

The present exemplary embodiment applies a drive roller 41 configured by the circular plates 47 in a ribbed shape as explained in the fourth exemplary embodiment.

FIG. 13 is an explanatory diagram showing a placement state of a remnant detection sensor in the present exemplary embodiment. Portions similar to those of FIG. 12 of the fourth exemplary embodiment are allocated the same reference numerals, and further explanation thereof omitted.

As shown in FIG. 13, a new pressure roller 49 is disposed at an internal angle θ with respect to the center of curvature O at the examination section 3 side of the pressure rollers 22 in the fourth exemplary embodiment. The configuration of the pressure roller 49 is similar to that of the pressure rollers 22.

Similarly to the switching timing sensor 5 of the fourth exemplary embodiment, the remnant detection sensor 50 is an optical sensor configured with sensor elements 50a, 50b disposed facing each other at the external of the drive roller 41. Furthermore, the remnant detection sensor 50 is disposed such that the optical axis passes between the pressure roller 49 and its adjacent pressure roller 22, and between the pressure roller 22 directly adjacent to the branching section 46 and the pressure roller 22 on the opposite side of this pressure roller 22 to the branching section 46.

The optical axis of the remnant detection sensor 50, similarly to that of the switching timing sensor 5 of the fourth exemplary embodiment, is disposed so as to pass through between the circular plates 47 having ribbed shape.

By adopting such a configuration, as shown in FIG. 13, when monitoring is desired of whether a jammed banknote or the like remains in the conveying path along the drive roller 41, the remnant detection sensor 50 can monitor two sections at once, enabling detection when a banknote remains in either of these sections.

When monitoring of other sections than these is also desired, it is possible to detect remnants in sections by providing plural sensors such that pairs of sensor elements can monitor two sections in the conveying path at the same time.

Similar effects are obtained according to the above configuration as those of the first exemplary embodiment. Furthermore, plural sections in the conveying path can be monitored by a single sensor by disposing the remnant detection sensors at the outside of the drive roller such that the optical axis passes between the circular plates. Monitoring plural sections in the conveying path with a single sensor results in a simple and low cost configuration, in which any banknotes remaining can be efficiently detected.

### EXPLANATION OF THE REFERENCE NUMERALS

1 customer interface section
2, 7, 8, 9, 10 conveying path
2a, 6 switching blade
3 examination section
5 switching timing sensor
5a, 5b, 50a, 50b sensor element
11 denominated cassettes
12 reject store
13 sorting conveying path
14, 15, 16 blades
20 circular arc shaped conveying path
21 feed rollers
21a, 22a, 41a rotational axis
22 pressure rollers
23, 24 conveying guides
41 drive roller
42 friction member
43 guide face
44 small diameter section
45 roller pair
46 branching section
47 circular plates
49 pressure roller
50 remnant detection sensor

1. A medium processing device comprising:
a customer interface section that comprises a deposit/withdrawal port for a banknote;
an examination section that examines a banknote;
a temporary holding section that holds a banknote;
a switching blade that switches a conveying direction of the banknote that has been examined by the examination section;
a switching timing sensor that detects a switching timing of the switching blade;
a denominated cassette that stores a banknote; and
a conveying path that connects each of the sections, the conveying path comprising a circular arc shaped conveying path formed in a circular arc shape at a portion of the conveying path connecting from the examination section to the customer interface section.

2. The medium processing device of claim 1, further comprising a branching section that includes the switching blade and is provided along the circular arc shaped conveying path, wherein the switching blade switches the conveying direction of the banknote toward the temporary holding section.

3. The medium processing device of claim 1, wherein the temporary holding section holds a withdrawal-rejected banknote.

4. The medium processing device of claim 1, wherein the circular arc shaped conveying path comprises a plurality of feed rollers and pressure rollers that press against the outer surface of the feed rollers.

5. The medium processing device of claim 1, wherein the circular arc shaped conveying path comprises a circular cylindrical shaped drive roller having a rotational axis at the center of curvature of the circular arc, and a plurality of pressure rollers that press against an outer surface of the drive roller.

6. The medium processing device of claim 5, wherein the drive roller comprises friction members at which the pressure rollers press against the outer surface of the drive roller, and the diameter of the drive roller is smaller at locations other than where the friction members is provided.

7. The medium processing device of claim 1, wherein the circular arc shaped conveying path comprises a drive roller having a rotational axis at the center of curvature of the circular arc and including a plurality of circular plates disposed at intervals along the rotational axis, and a plurality of pressure rollers that press the outer surfaces of the circular plates of the drive roller.

8. The medium processing device of claim 4, wherein the pressure rollers are disposed above the outer surface at intervals of about 60°.

9. The medium processing device of claim 4, further comprising
a branching section that includes the switching blade and is provided along the circular arc shaped conveying path, wherein the switching blade switches the conveying direction of the banknote toward the temporary holding section; and
a roller pair provided on the conveying path downstream from the switching by the switching blade provided at the branching section in the circular arc shaped conveying path, wherein the roller pair is disposed in a direction of about 120° with respect to tangents to respective nip portions of the pressure rollers provided before and after the branching section in the banknote conveying direction.

10. The medium processing device of claim 7, wherein the switching timing sensor comprises sensor elements disposed external to the drive roller such that an optical axis of the switching timing sensor passes between the circular plates.

11. The medium processing device of claim 7, further comprising a remnant detection sensor that detects a banknote remaining in the circular arc shaped conveying path, wherein sensor elements of the switching timing sensor are disposed external to the drive roller such that an optical axis of the switching timing sensor passes between the circular plates.

12. The medium processing device of claim 5, wherein the pressure rollers are disposed above the outer surface at intervals of about 60°.

13. The medium processing device of claim 7, wherein the pressure rollers are disposed above the outer surface at intervals of about 60°.

14. The medium processing device of claim 5, further comprising
a branching section that includes the switching blade and is provided along the circular arc shaped conveying path, wherein the switching blade switches the conveying direction of the banknote toward the temporary holding section; and
a roller pair provided on the conveying path downstream from the switching by the switching blade provided at the branching section in the circular arc shaped conveying path, wherein the roller pair is disposed in a direction of about 120° with respect to tangents to respective nip portions of the pressure rollers provided before and after the branching section in the banknote conveying direction.

15. The medium processing device of claim 7, further comprising
a branching section that includes the switching blade and is provided along the circular arc shaped conveying path, wherein the switching blade switches the conveying direction of the banknote toward the temporary holding section; and
a roller pair provided on the conveying path downstream from the switching by the switching blade provided at the branching section in the circular arc shaped conveying path, wherein the roller pair is disposed in a direction of about 120° with respect to tangents to respective nip portions of the pressure rollers provided before and after the branching section in the banknote conveying direction.
